(19) United States
(12) Patent Application Publication
(10) Pub. No.: US 2008/0097838 A1
(43) Pub. Date: Apr. 24, 2008

(54) Revenue-Based Advertising Auction

(75) Inventors: Zhouchen Lin, Beijing (CN); Benyu Zhang, Beijing (CN); Chenxi Lin, Beijing (CN); Zheng Chen, Beijing (CN); Pinyan Lu, Beijing (CN); Changyuan Yu, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/552,040

(22) Filed: Oct. 23, 2006

(51) Int. Cl. G06Q 30/00

(52) U.S. Cl. 705/14

(57) ABSTRACT

Implementations of a revenue-based advertising auction are described. Bidders submit advertisements to be assigned to ad slots such that each advertisement has an associated bid vector that indicates a value known to the auctioneer that the bidder is offering to pay for placement of the advertisement in each of the ad slots, respectively. Advertisements are assigned to ad slots on a web page such that a community revenue is maximized given the available advertisements and bid vectors A price is calculated for each advertisement allocated to an ad slot based on a contribution to the community revenue attributed to the advertisement.

### BACKGROUND

Many companies spend a lot of money each year on advertisements. In traditional advertising environments (e.g., newspaper, magazines, television, etc.), the price of an advertisement is typically based on visibility. For example, an ad that is placed on the front page of a newspaper is typically more expensive than an ad that is placed on the third page of the second section of the newspaper. Similarly, an advertiser will pay more to have an ad broadcast on television during primetime than he would pay to have the same ad broadcast on television at 2:00 am. With these traditional methods of advertising, the cost of the advertisement is known up-front, and the expected return on investment is based on the degree of visibility that the advertisement receives.

With Internet-based advertising, advertisers typically bid auction-style for placement of ads within a web page, with the bid price indicating the amount that the advertiser offers to pay the auctioneer, either per impression or per click-through. For example, a search engine website may have five ad slots in a column down the right hand side of a web page on which search results are displayed. Advertisers may bid for those spots in conjunction with a particular keyword that a user may enter for a search. For example, a company that sells camera equipment may place a bid to have their advertisement displayed when a user submits a search using the keyword “camera”. When a user submits a search using the keyword “camera”, the ads from the advertisers who have submitted the five highest bids in association with the keyword “camera” are displayed in the five ad slots, with the ad from the highest bidding advertiser on top (i.e., in the most desirable of the five available ad slots).

Along with their bids, advertisers also typically submit a budget amount. After their budget is reached (based on the price paid per received click-through of the ad), the ad is no longer displayed. Over time, advertisers have determined ways of increasing their revenue by submitting lower bids, which lowers the revenue for the auctioneer (e.g., a search engine) providing the advertising slots. For example, if an advertiser has a budget of $100, and bids 50 cents to win placement of the ad in the top slot on the web page, after 200 click-throughs (or impressions), the advertiser's budget will be exceeded, and the ad will no longer be shown. On the other hand, if the advertiser bids only 10 cents to win placement of the ad in the fourth slot on the web page, then the advertiser will receive 1000 click-throughs (or impressions) before the budget is exceeded. As a result, advertisers' revenues are increased while search engine revenues are reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A revenue-based advertising auction is described. Advertisements are submitted for presentation via ad slots on a web page. Each advertisement has an associated bid vector that identifies, for each available ad slot, a value that an advertiser offers to pay the auctioneer for placement of the advertisement in the ad slot. When the web page is requested, a subset of the advertisements is selected and mapped to the available ad slots such that a community revenue (the sum of the auctioneer's anticipated revenue and the advertisers' anticipated revenues) is maximized given the available advertisements and bid vectors. A price to be charged is calculated for each advertisement mapped to an ad slot based on the bid vector of the advertisement and the portion of the community revenue that can be attributed to the advertisement. The revenue-based advertising auction is implemented such that when a new advertisement is added to the set of available advertisements; the auctioneer experiences a non-negative change in anticipated revenue, and the other advertisements experience a non-positive change in anticipated revenue.

### BRIEF DESCRIPTION OF THE DRAWINGS

FIG. 1 is a pictorial diagram that illustrates an exemplary slot allocation strategy according to a revenue-based advertising auction.

FIG. 2 is a pictorial diagram that illustrates addition of a fourth advertisement in an exemplary revenue-based advertising auction.

FIG. 3 is. a block diagram that illustrates an exemplary network environment in which a revenue-based advertising auction may be implemented.

FIG. 4 is a flow diagram that illustrates an exemplary method for implementing a revenue-based advertising auction.

### DETAILED DESCRIPTION

The embodiments of a revenue-based advertising auction described below provide techniques for matching advertisements to ad slots and determining a price for each slot such that a community revenue (i.e., the sum of the auctioneer's expected revenue and the advertisers' expected revenue) is maximized. The revenue-based advertising auction may be implemented such that the advertisers are charged a price per impression or such that the advertisers are charged a price each time a user clicks on the ad (a click-through price). When implemented with click-through pricing, each advertiser's expected revenue is calculated as the difference between the revenue the advertiser expects to receive if a user clicks on the ad and the click-through price that the advertiser will pay to the auctioneer. The auctioneer's expected revenue is calculated as the sum of the click-through prices that each of the advertisers will pay if their advertisement is selected by a user. Advertiser and auctioneer revenues can be similarly calculated when the revenue-based advertising auction is implemented with per-impression pricing.

A revenue-based advertising auction as described herein includes strategies for ad slot allocation and strategies for pricing. The ad slot allocation and pricing strategies of a revenue-based advertising auction can be defined in terms of a series of mathematical equations. Given K ad slots and N bidders, each bidder i has a utility function uᵢ, where:

uᵢ=(uᵢ(1), uᵢ(2), . . . , uᵢ(K)),

where uᵢ(j) is equal to the true value that the bidder i is willing to pay if the advertisement is placed in the j^{th} ad slot. Each bidder submits a bid vector bᵢ where:

bᵢ=(bᵢ(1), bᵢ(2), . . . , bᵢ(K)),

where bᵢ(j) is the amount that the bidder offers to pay the auctioneer if the advertisement is placed in the j^{th} ad slot. As described herein, the revenue-based advertising auction is considered to be “truthful” if each bidder is motivated to submit a bid vector bᵢ such that bᵢ=uᵢ.

According to the received bid vectors, a mapping σ:[K]→[N] is generated such that the k^{th} ad slot is allocated to the σ(k)^{th} bidder, with no more than one ad slot allocated to any one bidder. If σ(j)=i (i.e., ad slot j is allocated to bidder i), then bidder i will be charged a price pᵢ(j). The revenue rᵢ for the i^{th} bidder is defined as:

rᵢ=uᵢ(j)−pᵢ(j).

Given utility function uᵢ and bid vector bᵢ for i=1, . . . , N, mapping σ is determined such that the community revenue R(u) is maximized. This is represented as:

$${σ}_{u} = arg {max}_{φ} R ( φ , u ) , \\ where \text{:}$$

$$R ( φ , u ) = {\sum }_{j = 1}^{K} [ {u}_{φ ( j )} ( j ) - {p}_{φ} ( j ) ] + {\sum }_{j = 1}^{K} {p}_{φ} ( j ) = {\sum }_{j = 1}^{K} {u}_{φ ( j )} ( j ) .$$

This equation shows that the community revenue is independent of the pricing strategy, but rather, is a function of the slot allocation, given the utility function. Because the auctioneer is typically unaware of a bidder's utility function, and is only aware of the bidder's bid vector, the slot allocation strategy is modified to find σ_{b} such that:

$${σ}_{b} = \text{arg} {max}_{φ} R ( φ , b ) .$$

Accordingly, the community revenue is maximized when, for each bidder, b=u. In other words, the community revenue is maximized if the auction is truthful.

Any number of techniques may be used to determine σ_{b}, such as, for example, the well-known Hungarian algorithm that finds the maximum matching in a bi-partite graph, where the slots and the bidders are the vertices and the weight on the edge linking a bidder i and a slot j is bᵢ(j).

In an exemplary implementation, advertisers submit advertisements to an ad slot provider (e.g., a web page owner/auctioneer). The advertisements are then maintained by the ad slot provider such that the advertisements may be presented to a user via an ad slot at some future time. In addition to submitting an advertisement, an advertiser also submits a bid value and optionally, a budget value. The bid value indicates the amount that the advertiser offers to pay the auctioneer when an advertisement is placed in an ad slot (per impression or per click-through). The budget value indicates a maximum value that the advertiser is willing to pay for placement of a particular advertisement over a fixed period of time (e.g., one day, one week, or one month). If an advertiser submits a budget value for an advertisement, then the advertisement is only available for placement in an ad slot if the submitted budget value for the advertisement has not yet been reached.

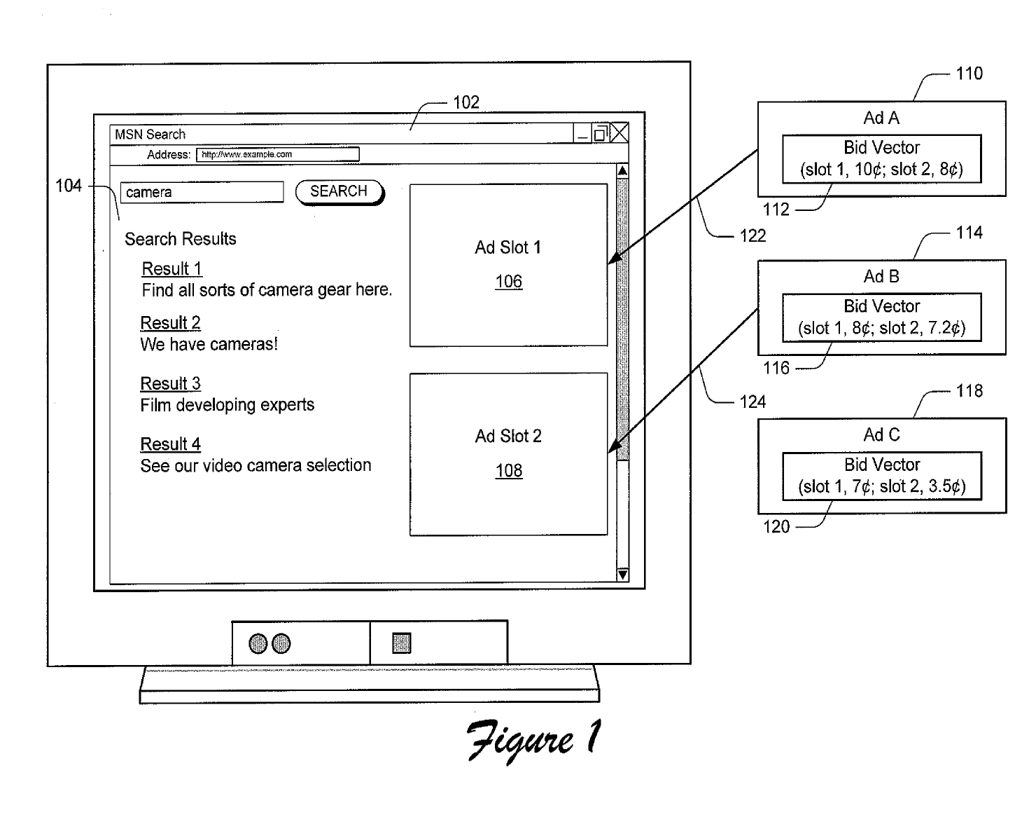

FIG. 1 illustrates an exemplary slot allocation strategy according to a revenue-based advertising auction. In the illustrated example, web page 102 contains search results 104, ad slot 106, and ad slot 108. In the illustrated example, three advertisers are bidding for placement of their ads in the two available ad slots. Each advertiser submits a bid vector that specifies the advertiser's bid value for each ad slot. For example, for “Ad A” 110, bid vector 112 indicates that the advertiser is offering to pay up to 10¢ if the ad is placed in the first ad slot 106, and that the advertiser is offering to pay up to 8¢ if the ad is placed in the second ad slot 108. Similarly, for “Ad B” 114, bid vector 116 indicates the respective prices known to the auctioneer that the advertiser is offering to pay if the ad is placed in the first ad slot 106 or the second ad slot 108; and for ¢Ad C∞ 118, bid vector 120 indicates the respective prices known to the auctioneer that the advertiser is offering to pay if the ad is placed in the first ad slot 106 or the second ad slot 108.

Table 1 summarizes the bid vectors submitted by advertisers 110, 114, and 118, as shown in FIG. 1.

TABLE 1

| Advertisement | Ad Slot 1 Bid | Ad Slot 2 Bid |
|---|---|---|
| Ad A | 10 ¢ | 8 ¢ |
| Ad B | 8 ¢ | 7.2 ¢ |
| Ad C | 7 ¢ | 3.5 ¢ |

Table 2 illustrates each of the possible slot allocations and the respective commnunity revenues.

TABLE 2

| Ad Slot 1 | Ad Slot 2 | Community Revenue |
|---|---|---|
| Ad A (10 ¢) | Ad B (7.2 ¢) | 17.2 ¢ |
| Ad A (10 ¢) | Ad C (3.5 ¢) | 13.5 ¢ |
| Ad B (8 ¢) | Ad A (8 ¢) | 16 ¢ |
| Ad B (8 ¢) | Ad C (3.5 ¢) | 11.5 ¢ |
| Ad C (7 ¢) | Ad A (8 ¢) | 15 ¢ |
| Ad C (7 ¢) | Ad B (7.2 ¢) | 14.2 ¢ |

Based on the data shown in Table 2, in this example, the community revenue is maximized when “Ad A” 110 is assigned to the first ad slot 106 and “Ad B” 114 is assigned to the second ad slot 108 as represented by arrows 122 and 124, respectively.

In addition to the slot allocation strategy described above, the revenue-based advertising auction also includes a pricing strategy that is used to determine the price to be paid by the winning bidders. The pricing strategy of the revenue-based advertising auction is referred to as a revenue difference pricing (RDP) strategy. By definition, for a bidder i, the bidder's expected income is given by the bidder's utility function uᵢ, where uᵢ(j) is equal to the income bidder i expects to receive if the advertisement is placed in the j^{th} ad slot. Assuming the bidder bids truthfully such that uᵢ=bᵢ, then 0≦p_{σ}(i)≦bᵢ(j) for i ∈ σ ([K]). This ensures that the bidding strategy is meaningful because charging a negative price (i.e., p_{σ}(i)<0) is equivalent to the auctioneer paying the winning bidder, and would reduce the revenue of the auctioneer. Similarly, because the bid vector submitted by the bidder indicates the prices the bidder is willing to pay, then by definition of the bid vector, p_{σ}(i)≦bᵢ(j). Accordingly, if uᵢ=bᵢ, then 0≦p_{σ}(i)≦bᵢ(j) for i ∈ σ([K]).

For the bidder i in σ([K]), where i=σ(j), the price to be charged to bidder i is determined according to the RDP strategy by first calculating what the maximum community revenue would be if bidder i was not participating in the auction, represented by OPT(b⁻ⁱ). When bidder i is participating in the auction, the revenue of the others in the community (all except bidder i) is represented as:

$${\sum }_{k \neq j}^{ } {b}_{σ ( k )} ( k ) .$$

The difference between the community revenue when bidder i is a participant and the community revenue when bidder i is not a participant is used to calculate the price bidder i is charged, as follows:

$${p}_{σ} ( i ) = OPT ( {b}^{- i} ) - {\sum }_{k , σ ( k ) \neq i}^{ } {b}_{σ ( k )} ( k ) = {b}_{i} ( j ) - ( OPT ( b ) - OPT ( {b}^{- 1} ) ) ,$$

where OPT(b) represents the maximum community revenue when bidder i is a participant in the auction.

Given the example shown in FIG. 1, the price charged to the bidder (i.e., advertiser) associated with “Ad A” 110 is calculated as:

p_{σ}(i)=bᵢ(j)−(OPT(b)−OPT(bⁱ))=0.10−(0.172−0.142)=0.10−0.03=0.07.

Accordingly, the bidder associated with “Ad A” 110 will be charged 7¢. Similarly, the price charged to the bidder (i.e., advertiser) associated with “Ad B” 114 is calculated as:

p_{σ}(i)=bᵢ(OPT(b)−OPT(b⁻ⁱ))=0.072−(0.172−0.15)=0.072−0.022=0.05.

### Accordingly, the bidder associated with “Ad B” will be charged 5¢.

The slot allocation strategy and the RDP strategy described above are based on the assumption that the revenue-based advertising auction is truthful. However, as will be shown, the truthfulness of the revenue-based advertising auction is more than an assumption, in that it can be proved. For bidder i, the bidder's revenue is compared under two bidding strategies, a first bidding strategy in which the bidder bids truthfully with uᵢ and a second bidding strategy in which the bidder bids with an arbitrary bid bᵢ. It is assumed that the bids from the rest of the bidders are unchanged and are denoted by b⁻ⁱ. The bids under the two bidding strategies are represented by (uᵢ, b⁻ⁱ) and (bᵢ, b⁻ⁱ), respectively.

Without loss of generality, it is assumed that bidder i is assigned an ad slot when the bid bⁱ is submitted. Otherwise, the revenue of bidder i would be zero, in which case the revenue for bidder i under the non-truthful strategy would not exceed the revenue for bidder i under the truthful strategy.

For the truthful bidding strategy, according to the above-described RDP strategy, the revenue of bidder i is represented as:

rᵢ=OPT(uᵢ,bⁱ)−OPT(bⁱ)

Similarly for the untruthful bidding strategy with arbitrary bid bᵢ, if i=σ(j), where σis the optimal assignment, then the revenue for bidder i is represented as

$${r}_{i}^{′} = {u}_{i} ( j ) - ( OPT ( {b}^{- i} ) - {\sum }_{k , σ ( k ) \neq i}^{ } {b}_{σ ( k )} ( k ) ) = ( {u}_{σ ( j )} ( j ) + {\sum }_{k , σ ( i ) \neq i}^{ } {b}_{σ ( k )} ( k ) ) - OPT ( {b}^{- i} )$$

Because the first part of the calculation for the revenue according to the non-truthful bidding strategy is a feasible solution in the truthful RDP strategy:

$$OPT ( {u}_{i} , {b}^{- i} ) \geq {u}_{σ ( j )} ( j ) + {\sum }_{k , σ ( k ) \neq i}^{ } {b}_{σ ( k )} ( k )$$

Combining the above three equations leads to the conclusion that rₜ≧rₜ^{r}, indicating that the revenue of a bidder is maximized when the bidder bids truthfully. Accordingly, the revenue-based advertising auction as described herein that utilizes the RDP strategy is truthful in that it motivates each bidder to bid their utility function.

Furthermore, it can be proven that the RDP strategy is unique to make the revenue-based advertising auction truthful. First it is proven that given that a bidder i bids with bᵢ, and another n-1 bidders bid wit b⁻ⁱ; and that bidder i is assigned ad slot j by σ_{b} and the bid bᵢ* satisfies bᵢ*(k)=0,∀k≠j; then, when bᵢ*(j)≧p₉₄ _{_{b}}(i), the available ad slots can be assigned by σ_{b*} (where b*=(bᵢ*, b⁻ⁱ)) to the same bidders as by σ_{b}; and when bᵢ*(j)<p_{σ}_{_{b}}b(i), bidder i will not be assigned a slot.

By definition:

$${b}_{i} ( j ) + {\sum }_{k \neq j}^{K} {b}_{{σ}_{b} ( k )} ( k ) = {max}_{φ} {\sum }_{k = 1}^{K} {b}_{φ ( k )} ( k ) , \\ and$$

$${p}_{{σ}_{b}} ( i ) = OPT ( {b}^{- i} ) - {\sum }_{k \neq j}^{K} {b}_{{σ}_{b} ( k )} ( k ) .$$

When bᵢ is replaced with bᵢ* and bᵢ*(j)≧p_{σb}(i), it follows that:

$${b}_{i}^{*} ( j ) + {\sum }_{k \neq j}^{K} {b}_{{σ}_{b} ( k )} ( k ) \geq OPT ( {b}^{- i} ) .$$

Accordingly, σ_{b*} will assign a slot to bidder i and more specifically, will assign slot j to bidder i because bᵢ*(k)=0,∀k≠j. Because bidder i will be assigned the same slot, the other bidders will also be assigned the same slots. In other words, when bᵢ*(j)≧p_{σ}_{_{b}}(i), the available ad slots are assigned by σ_{b*} (where b*=(bᵢ*, b⁻ⁱ)) to the same bidders as by σ_{b}.

When bᵢ is replaced with bᵢ* and bᵢ*(j)<p_{σ}_{_{b}}(i), it follows that:

$${b}_{i}^{*} ( j ) + {\sum }_{k \neq j}^{K} {b}_{{σ}_{b} ( k )} ( k ) \geq OPT ( {b}^{- i} ) .$$

### Accordingly, bidder i will not be assigned a slot.

Now, to complete the proof that the RDP strategy is unique to make the revenue-based advertising auction truthful, it is supposed that there are two pricing strategies that make the revenue-based advertising auction truthful: T, which represents the RDP strategy, and T*, which represents the other truthful pricing strategy. For any bidder i with bid bᵢ and utility function uᵢ, if bidder i is assigned slot j, then p(i) and p*(i) represent the price that bidder i will be charged according to pricing strategies T and T*, respectively.

If p*(i)>p(i), then as shown above, bᵢ can be replaced with bᵢ*=(0, . . . ,0,bᵢ*(j),0, . . . ,0), and bidder i will still be assigned slot j if bᵢ*(j)≧p(i). If bᵢ*(j)=(p*(i)+p(i))/2, it follows that p*(i)>bᵢ*(j), which is in conflict with the basic requirement that the price charged to a bidder is not greater than the bidder's bid. Accordingly, p*(i)≦p(i).

If p*(i)<p(i), then when uᵢ(j) is between p*(i) and p(i), and uᵢ(k)=0,∀k≠j, bidder i may bid with any bid bᵢ* that satisfies bᵢ*(j)≧p(i) and b_{σ(k)}*(k)=0,∀k≠j to be assigned slot j and receive positive revenue according to the truthful pricing strategy T* because uᵢ (j)>p_{σ}*(i). However, if bidder i bids truthfully, bidder i will not be assigned a slot because uᵢ(j)<p_{σ}*(i). Accordingly, bidder i is not motivated to bid truthfully. This is in conflict with the definition of T* as a truthful pricing strategy. It follows that p*(i)=p(i), and T*=T. Therefore the RDP strategy is unique to make the revenue-based advertising auction truthful.

Another characteristic of the revenue-based advertising auction is that when a new bidder joins the revenue-based advertising auction, the auctioneer will have a non-negative change in revenue, and each of the existing bidders will each have a non-positive change in revenue. This is proven as follows.

First, we present a lemma. Let G=(V₁ Å V₂,E) be a weighted bi-partite graph. For A ⊂ V₁, let M(A) denote the value of the maximum weighted matching in the subgraph indicated by the vertices A ⊂ V₂. Then: M(A+i)−M(A)≧M(A+i+j)−M(A+j), where A+i=A ∪ {i}.

Given a set of bidders A, any bidder i ∈ A, a new bidder k, the slots set V, and everybody bidding truthfully, we use R(A) to denote the community revenue when the auction takes place among the bidders in A Let rᵢ be the bidder i's revenue from this auction among A, and rᵢ be that from the new auction among A ∪ {k}. It follows that:

rᵢ=R(A)−R(A \{i}), and

rᵢ′(A ∪ {k})−R((A ∪ {k})\{i}).

Based on the slot allocation strategy described above, it is clear that R(A) represents the maximum weighted matching between the bidders A and the slots set V, denoted by M(A). Furthermore, based on the discussion above, it is known that M is a submodular function of A. Accordingly, R(A) is also submodular, and

R(A)−R(A \{i})≧R(A ∪ {k})−R((A ∪ {k}\{i}).

This leads to Δrᵢ′=r;≦0, and i is selected from A arbitrarily. As the increased community revenue is taken by the new bidder, the auctioneer accordingly receives the loss of the existing bidders.

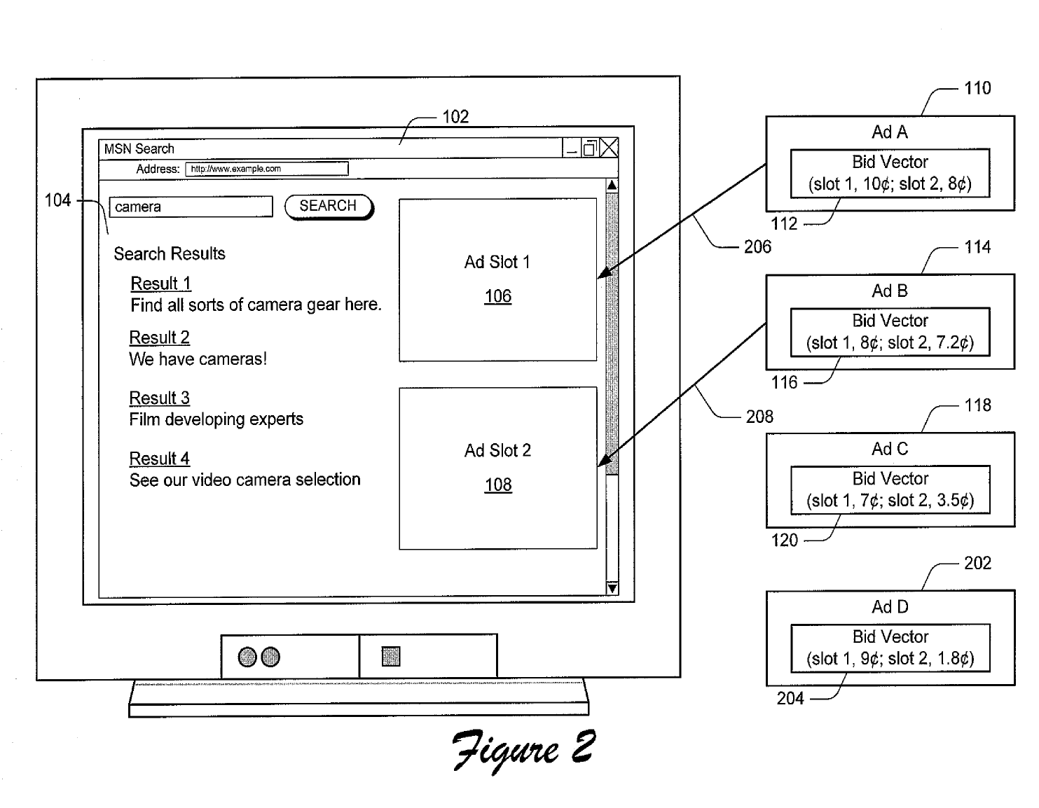

FIG. 2 illustrates how when a new bidder joins the auction, the auctioneer experiences a non-negative change of revenue and each of the existing bidders experiences a non-positive change of revenue. As shown in FIG. 1 and described above, when Ad A 110, Ad B 114, and Ad C 118 are bidding against one another for placement in ad slots 106 and 108, Ad A 110 is assigned to ad slot 106, Ad B is assigned to ad slot 108, and the auctioneer's revenue is 13.98¢.

FIG. 2 illustrates the same auction as shown in FIG. 1, but with the addition of a fourth bidder, associated with Ad D 202 having bid vector 204. Table 3 summarizes the bid vectors submitted by advertisers 110, 114, 118, and 202 as shown in FIG. 2.

TABLE 3

| Advertisement | Ad Slot 1 Bid | Ad Slot 2 Bid |
|---|---|---|
| Ad A | 10 ¢ | 8 ¢ |
| Ad B | 8 ¢ | 7.2 ¢ |
| Ad C | 7 ¢ | 3.5 ¢ |
| Ad D | 9 ¢ | 1.8 ¢ |

Table 4 illustrates each of the possible slot allocations and the respective community revenues.

TABLE 4

| Ad Slot 1 | Ad Slot 2 | Community Revenue |
|---|---|---|
| Ad A (10 ¢) | Ad B (7.2 ¢) | 17.2 ¢ |
| Ad A (10 ¢) | Ad C (3.5 ¢) | 13.5 ¢ |
| Ad A (10 ¢) | Ad D (1.8 ¢) | 11.8 ¢ |
| Ad B (8 ¢) | Ad A (8 ¢) | 16 ¢ |
| Ad B (8 ¢) | Ad C (3.5 ¢) | 11.5 ¢ |
| Ad B (8 ¢) | Ad D (1.8 ¢) | 9.8 ¢ |
| Ad C (7 ¢) | Ad A (8 ¢) | 15 ¢ |
| Ad C (7 ¢) | Ad B (7.2 ¢) | 14.2 ¢ |
| Ad C (7 ¢) | Ad D (1.8 ¢) | 8.8 ¢ |
| Ad D (9 ¢) | Ad A (8 ¢) | 17 ¢ |
| Ad D (9 ¢) | Ad B (7.2 ¢) | 16.2 ¢ |
| Ad D (9 ¢) | Ad C (3.5 ¢) | 12.5 ¢ |

Based on the data shown in Table 4, in this example, the community revenue is still maximized when “Ad A” 110 is assigned to the first ad slot 106 and “Ad B” 114 is assigned to the second ad slot 108, as represented by arrows 206 and 208, respectively.

According to the RDP strategy described above, the price charged to the bidder (i.e., advertiser) associated with “Ad A” 110 when a fourth bidder is involved is calculated as:

p_{σ}(i)=bᵢ(j)−(OPT(b)−OPT(b⁻ⁱ)=0.10−(0.172−0.162)=0.10−0.01=0.09.

Accordingly, the bidder associated with “Ad A” 110 is charged 9¢ when four bidders are involved in the auction and only 7¢ when only three bidders are involved in the auction. This shows that the bidder associated with “Ad A” 110 experiences a non-positive change of revenue.

Similarly, the price charged to the bidder (i.e., advertiser) associated with “Ad B” 114 when a fourth bidder is involved is calculated as:

p_{σ}(i)=bᵢ(j)−(OPT(b)−OPT(b^{<i}))=0.072−(0.172−0.17)=0.072−0.002=0.07.

Accordingly, the bidder associated with “Ad B” 114 will be charged 7¢ when four bidders are involved in the auction and only 5¢ when only three bidders are involved in the auction. This shows that the bidder associated with “Ad B” 114 also experiences a non-positive change of revenue.

Furthermore, the auctioneer's revenue before the addition of the fourth bidder is 12¢, and the auctioneer's revenue after the addition of the fourth bidder is 16¢, illustrating a non-negative change in revenue for the auctioneer.

While features of a revenue-based advertising auction can be implemented in any number of different computing environments, they are described in the context of the following exemplary implementations.

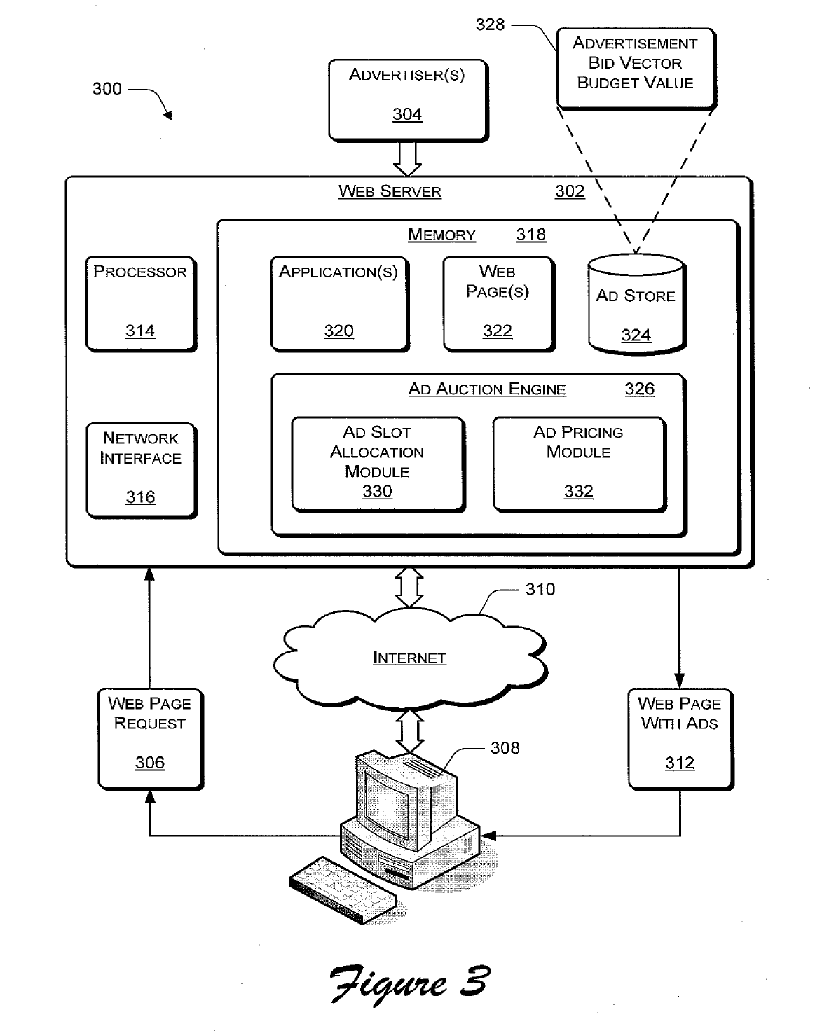

FIG. 3 illustrates an exemplary network environment 300 in which a revenue-based advertising auction may be implemented. A web server 302 hosts one or more web pages that may display advertisements. One or more advertisers 304 submit advertisements to web server 302. Each advertisement includes a bid vector that indicates a price known to the auctioneer that the advertiser is offering to pay for placement of their advertisement in each available ad slot. A web page request 306 may be submitted via computer system 308 to web server 302 via a network such as the Internet 310. Web server 302 dynamically inserts advertisements into the web page, and returns the requested web page with ads 312.

Selected components of web server 302 may include a processor 314, a network interface 316, and memory 318. Network interface 316 enables web server 302 to receive data from advertiser(s) 304, and to communicate with computer system 308 over the Internet 310. One or more applications 320, one or more web pages 322, ad store 324, and ad auction engine 326 are maintained in memory 318 and executed on processor 314.

Web pages 322 each include one or more ad slots via which advertisements received from advertisers 304 may be presented. Ad store 324 maintains data associated with advertisements received from advertisers 304. Data 328 that may be maintained may include, but is not limited to, an advertisement, a bid vector, and a budget value. As described above, the bid vector indicates values known to the auctioneer that the advertiser is offering to pay (e.g., per impression or per click-through) for placement of the ad in each of the available ad slots, and the budget value indicates a maximum value that the advertiser is willing to pay for placement of the ad over a particular period of time. For example, an advertiser may indicate a budget of $50 per day, or $1000 per month.

Ad auction engine 326 includes ad slot allocation module 330 and ad pricing module 332. Ad slot allocation module 330 is configured to determine which ads in ad store 324 are to be presented via a particular web page 322, and which of the identified ads are to be presented in each of the available ad slots. As described above with reference to FIGS. 1, exemplary ad slot allocation module 330 allocates advertisements to available ad slots such that the community revenue is maximized. Ad pricing module 332 is configured to determine for each ad allocated to an ad slot, a price to be charged for placement of the ad (e.g., per impression or per click-through) according to the revenue difference pricing (RDP) strategy described above.

Methods for implementing a revenue-based advertising auction may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

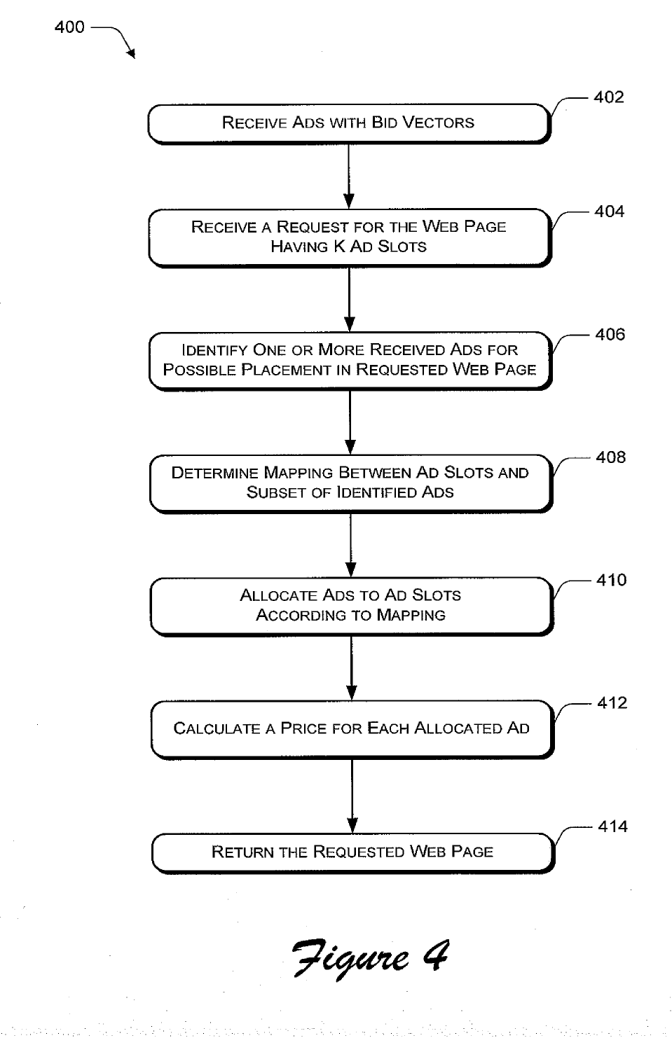

FIG. 4 illustrates an exemplary method 400 for implementing a revenue-based advertising auction. FIG. 4 is a specific example of a revenue-based advertising auction implementation, and is not to be construed as a limitation. Furthermore, it is recognized that various embodiments may implement any combination of portions of the method illustrated in FIG. 4. The order in which the method is described is not intended to be construed as a limitation, and any number of the described method blocks can be combined in any order to implement the method. Furthermore, the method can be implemented in any suitable hardware, software, firmware, or combination thereof.

At block 402, ads with associated bid vectors are received. Each bid vector indicates, for each of a plurality of available ad slots, a value known to the auctioneer that an advertiser is offering to pay for placement of the ad in each of the respective ad slots. As described above, depending on the implementation, the values represented by the bid vector may represent, for example, the prices offered by the advertiser to be paid per impression or per click-through. For example, web server 302 may receive one or more advertisements and bid vectors from advertiser(s) 304. In an exemplary implementation each bid vector is associated with a particular web site, and in the case of a search engine web site, optionally also a particular keyword. In an exemplary implementation, a budget value may also be received with an advertisement.

At block 404, a request for a particular web page having K ad slots is received. For example, web server 302 receives web page request 306 from computer system 308 via the Internet 310.

At block 406, one or more of the received ads are identified for possible placement in the requested web page. For example, ad auction engine 326 queries ad store 324 to identify the received ads that may be placed in available ad slots on the requested web page. As one example, placement of a particular ad on a particular web page may be based on a keyword that was entered by a user as search criteria.

At block 408, a mapping between the ad slots and a subset of the identified ads is determined such that the determined mapping results in the greatest community revenue compared to other possible mappings between the ad slots and subsets of the identified ads. Any number of techniques may be used to determine the mapping such as, for example, the well-known Hungarian algorithm that finds the maximum matching in a bi-partite graph.

At block 410 a subset of the identified ads are allocated to the available ad slots according to the determined mapping.

At block 412, a price is calculated for each allocated ad. For example, for each ad, the price is calculated as p=bᵢ(j)−(OPT(b)−OPT(b⁻ⁱ)), where bᵢ(j) represents the value indicated by the bid vector associated with the advertisement for the j^{th} ad slot, to which the advertisement has been allocated; OPT(b) represents the maximized community revenue when the current advertisement is participating in the advertising auction; and OPT(b⁻ⁱ) represents the maximum community revenue in a hypothetical scenario in which the current advertisement is removed from participation in the advertising auction.

At block 414, the requested web page is returned. For example, web server 302 transmits the web page with ads 312 to computer system 308 over the Internet 310.

Although embodiments of a revenue-based advertising auction have been described in language specific to structural features and/or methods, it is to be understood that the subject of the appended claims is not necessarily limited to the specific features or methods described. Rather, the specific features and methods are disclosed as exemplary implementations of a revenue-based advertising auction.

1. A system comprising:
a processor;
memory;
an ad auction engine maintained in the memory and executed on the processor, wherein the ad auction engine is configured to allocate advertisements to available ad slots so as to maximize a community revenue.

2. The system as recited in claim 1, wherein the community revenue is defined as the sum of the anticipated revenue of an auctioneer providing the ad slots and the anticipated revenue of each of a plurality of bidders each associated with a particular one of a plurality of advertisements that may be allocated to any one of the available ad slots.

3. The system as recited in claim 2, wherein the anticipated revenue of the auctioneer is defined as a sum of prices to be charged to the bidders associated with the advertisements that are allocated to the ad slots.

4. The system as recited in claim 2, wherein the anticipated revenue of a particular one of the plurality of bidders is defined as a difference between a bid value associated with the advertisement for the allocated ad slot and a price to be charged for the advertisement allocated to the ad slot.

5. The system as recited in claim 1, wherein the ad auction engine comprises:
an ad slot allocation module configured to allocate advertisements to available ad slots, such that an anticipated community revenue is maximized; and
an ad pricing module configured to calculate prices to be charged in association with each of the allocated advertisements such that for a particular one of the allocated advertisements, the price to be charged is calculated based on a bid value associated with the particular advertisement and a contribution to the community revenue attributed to the particular advertisement.

6. The system as recited in claim 5, wherein the price to be charged in association with the particular advertisement i is calculated as bᵢ−(OPT(b)−OPT(b⁻ⁱ)), wherein:
bᵢ represents a bid value associated with the advertisement i;
OPT(b) represents the maximum anticipated community revenue when advertisement i may be allocated to an ad slot; and
OPT(b⁻ⁱ) represents the maximized anticipated community revenue if advertisement i were not able to be allocated to an ad slot.

7. A method implemented at least in part by a computing device, the method comprising:
identifying a plurality of ad slots, wherein the number of the plurality of ad slots is represented as K;
identifying a plurality of advertisements, wherein the number of the plurality of advertisements is represented as N such that N>K; and
receiving, in association with each of the plurality of advertisements, a bid vector bᵢ where bᵢ=(bᵢ(1), bᵢ(2), . . . bᵢ(K)) where:
bᵢ(j) is equal to a price that a bidder associated with the i^{th} advertisement offers to pay the auctioneer if the i^{th} advertisement is placed in the j^{th} ad slot;
1≦j≦K; and
1≦i≦N.

8. The method as recited in claim 7, further comprising mapping K of the N advertisements to the K ad slots such that the sum of the bids associated with the K advertisements mapped to the K ad slots is the maximum possible sum of bids for any K of the N advertisements that could be mapped to the K ad slots according to the bid vectors.

9. The method as recited in claim 7, further comprising generating a mapping σ:[K]→[N] such that:
the j^{th} had slot is allocated to the σ(j)^{th} advertisement, with no more than one of the plurality of ad slots allocated to any one of the plurality of advertisements; and
the sum of the bid values
$${\sum }_{j = 1}^{K} {b}_{σ ( k )} ( k )$$
is maximized for the bid vectors bᵢ.

10. The method as recited in claim 9, wherein the mapping σ:[K]→[N] is generated based on the Hungarian algorithm for finding the maximum matching in a bipartite graph.

11. The method as recited in claim 9, further comprising calculating a price to charge each of the bidders associated with the advertisements σ(j) where 1≦j≦K.

12. The method as recited in claim 11, wherein calculating the price to charge each of the bidders comprises, for each bidder i associated with the advertisement allocated to ad slot k, calculating the price to be equal to the bidder's bid value for the k^{th} slot minus the difference between a maximum community revenue when bidder i is involved in the auction and a maximum community revenue that could be obtained if bidder i were not involved in the auction.

13. The method as recited in claim 11, wherein calculating the price comprises:
defining a set A of the N advertisements;
calculating a community revenue
$$R = {\sum }_{j = 1}^{k} ( {b}_{σ ( j )} ( j ) )$$
wherein R represents the sum of the revenue of an auctioneer providing the plurality of ad slots and the bidders; and
for each advertisement σ(j), assigned to the j^{th} slot:
determining a set A′ of N-1 advertisements as a subset of the set A such that the set A′ does not include the advertisement σ(j);
generating a mapping σ′:[K]→[N-1] such that:
the k^{th} ad slot is allocated to the σ′(k)^{th} advertisement, with no more than one of the plurality of ad slots allocated to any one of the plurality of advertisements; and
the sum of the bid values
$${\sum }_{k = 1}^{K} {b}_{{σ}^{′} ( k )} ( k )$$
is maximized for the bid vectors bᵢ;
calculating a secondary community revenue
$${R}^{′} = {\sum }_{j = 1}^{k} ( {b}_{{σ}^{′} ( j )} ( j ) )$$
wherein R′ is equal to the maximum possible sum of bids for any K of the N-1 advertisements that could be mapped to the K ad slots according to the bid vectors wherein advertisement σ(j) is not one of the N-1 advertisements; and
setting the price equal to (b_{σ(j)}(i)−(R−R′)).

14. One or more tangible computer-readable media comprising computer-readable instructions that, when executed, cause a computer system to:
receive a plurality of advertisements to be placed in a web page having a plurality of available ad slots;
for each of the plurality of advertisements, receive a bid vector indicating, for each of the available ad slots, an amount known to the auctioneer that an advertiser is offering to pay for placement of the advertisement in the ad slot;
receive a request for the web page;
allocate a subset of the plurality of advertisements to the available ad slots such that none of the advertisements is allocated to more than one of the ad slots;
calculate a price to be associated with each of the subset of the plurality of advertisements; and
return the requested web page.

15. The one or more tangible computer-readable media as recited in claim 14, wherein the price to be associated with each of the subset of the plurality of advertisements comprises a price-per-impression.

16. The one or more tangible computer-readable media as recited in claim 14, wherein the price to be associated with each of the subset of the plurality of advertisements comprises a click-through price.

17. The one or more tangible computer-readable media as recited in claim 14, wherein adding another advertisement to the plurality of advertisements causes:
each of the plurality of advertisements to experience a non-positive change in anticipated revenue; and
an auctioneer providing the ad slots to experience a non-negative change in anticipated revenue.

18. The one or more tangible computer-readable media as recited in claim 14, wherein the subset of the plurality of advertisements is allocated to the available ad slots such that a community revenue is maximized.

19. The one or more tangible computer-readable media as recited in claim 14, wherein the price for each of the subset of the plurality of advertisements is calculated based, at least in part, on the bid vector associated with each of the plurality of advertisements.

20. The one or more tangible computer-readable media as recited in claim 14, wherein the price for a particular advertisement selected from the plurality of advertisements is calculated based, at least in part, on a contribution to the community revenue attributed to the particular advertisement.
